(19) United States
(12) Patent Application Publication
(10) Pub. No.: US 2021/0085434 A1
(43) Pub. Date: Mar. 25, 2021

(54) FLOSS STICK

(71) Applicants: Allen BAI, Kaohsiung City (TW); Kuan-Wen CHEN, Jiouru Township (TW); Jin-Kai CHEN, Jiouru Township (TW)

(72) Inventors: Allen BAI, Kaohsiung City (TW); Kuan-Wen CHEN, Jiouru Township (TW); Jin-Kai CHEN, Jiouru Township (TW)

(21) Appl. No.: 17/029,735

(22) Filed: Sep. 23, 2020

(30) Foreign Application Priority Data
Sep. 25, 2019 (TW) 108134627
Sep. 25, 2019 (TW) 108134628

(51) Int. Cl. A61C 15/04

(52) U.S. Cl. CPC A61C 15/046

(57) ABSTRACT

A floss stick includes a horizontal stick body, first and second extension arms, at least one horizontal floss, and at least one inclined floss. The first and second extension arms extend transversely from the stick body and are spaced apart from each other. The horizontal and inclined flosses are connected between the first and second extension arms and are adapted for removing dental plaque from teeth. The inclined floss is inclined relative to the horizontal floss, and cooperates with the horizontal floss to define a gap therebetween, in which the dental plaque removed is confined by capillary action.

### CROSS-REFERENCE TO RELATED APPLICATION

This application claims priority to Taiwanese Patent Application No. 108134627, filed on Sep. 25, 2019 and Taiwanese Patent Application No. 108134628, filed on Sep. 25, 2019.

### FIELD

The disclosure relates to a teeth cleaning device, more particularly to a floss stick.

### BACKGROUND

Dental plaque (also known as tartar) is a biological film that gradually accumulates on the surface of the teeth and causes many periodontal diseases such as gingivitis or periodontitis. Thus, it is very important to keep the teeth clean and to reduce dental plaque. Currently, most people use tooth brush, toothpaste and mouthwash to clean their mouth so as to remove the dental plaque from the surface of the teeth. However, the above approaches are not effective in removing the dental plaque between the teeth.

Conventional floss sticks are used to remove substances (e.g., food residue or dental plaque) that accumulate between the teeth. Although the conventional floss sticks are capable of removing substances accumulating between the teeth, they are not effective in removing the dental plaque. Generally, the dental plaque is composed of microorganisms having a size ranging from 1 μm to 20 μm. For example, a dental plaque removal rate of a single floss stick is about 12% in one reciprocal action (movement of the floss into and out of a space between the teeth represents one reciprocal action), and the dental plaque removal rate of a floss stick with two parallel flosses is about 25% to 30% in one reciprocal action. When the microorganisms having a size larger than 5 μm, it is necessary to reciprocate the floss stick several times, e.g., four times, to remove the dental plaque so as to achieve a dental plaque removal rate of 70%.

### SUMMARY

Therefore, an object of the disclosure is to provide a floss stick capable of remove the dental plaque between teeth in a relatively efficient manner.

According to one aspect of the disclosure, a floss stick is provided to include a stick body, a first extension arm, a second extension arm, a first floss unit and a second floss unit. The stick body extends generally in a horizontal direction. The first extension arm extends from the stick body in an extension direction transverse to the horizontal direction. The second extension arm extends from the stick body in the extension direction, is spaced apart from the first extension arm in the horizontal direction, and cooperates with the first extension arm to define a cleaning area therebetween. The first floss unit is mounted in the cleaning area, is adapted for removing dental plaque from teeth, and includes a first horizontal floss. The first horizontal floss is connected between the first extension arm and the second extension arm, and extends in a direction generally parallel to the horizontal direction. The second floss unit is mounted in the cleaning area, is adapted for removing dental plaque from teeth, and includes a first inclined floss. The first inclined floss is connected between the first extension arm and the second extension arm, is inclined relative to the first horizontal floss, and cooperates with the first horizontal floss to define a first gap therebetween, in which the dental plaque removed is confined by capillary action.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a floss stick according to a first embodiment of the present disclosure;

FIG. 2 is a fragmentary side view of the floss stick of the first embodiment;

FIG. 3 is a fragmentary side view of the floss stick of a second embodiment;

FIG. 4 is a fragmentary side view of the floss stick according to a third embodiment;

FIG. 5 is a fragmentary side view of the floss stick of a fourth embodiment;

FIG. 6 is a fragmentary side view of the floss stick according to a fifth embodiment;

FIG. 7 is a fragmentary side view of the floss stick of a sixth embodiment;

FIG. 8 is a fragmentary side view of the floss stick of a seventh embodiment;

FIG. 9 is a fragmentary side view of the floss stick according to an eighth embodiment of the present disclosure;

FIG. 10 is a fragmentary side view of the floss stick of a ninth embodiment;

FIG. 11 is a fragmentary side view of the floss stick of a tenth embodiment;

FIG. 12 is a fragmentary side view of the floss stick of an eleventh embodiment;

FIG. 13 is a fragmentary side view of the floss stick of a twelfth embodiment;

FIG. 14 is a fragmentary side view of the floss stick of a thirteenth embodiment;

FIG. 15 is a fragmentary side view of the floss stick of a fourteenth embodiment; and

FIG. 16 is a fragmentary side view of the floss stick of a fifteenth embodiment.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

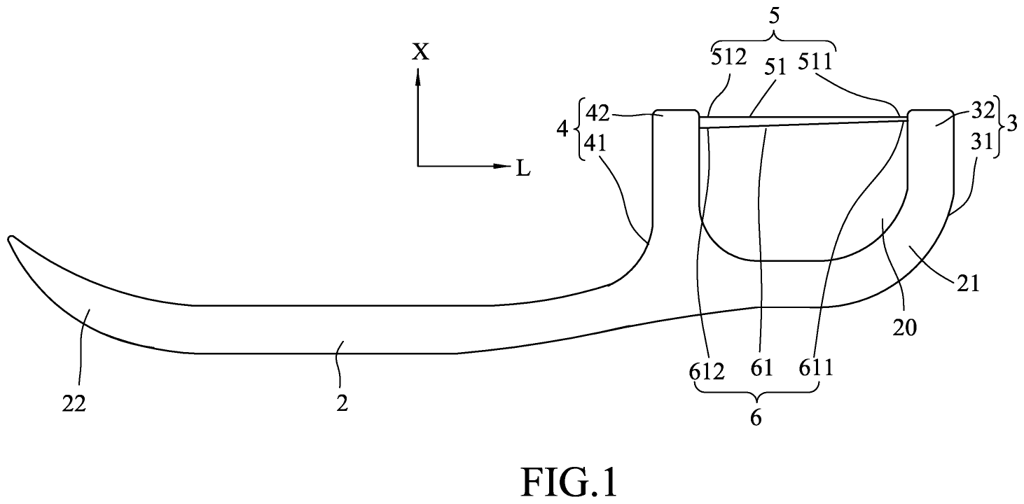

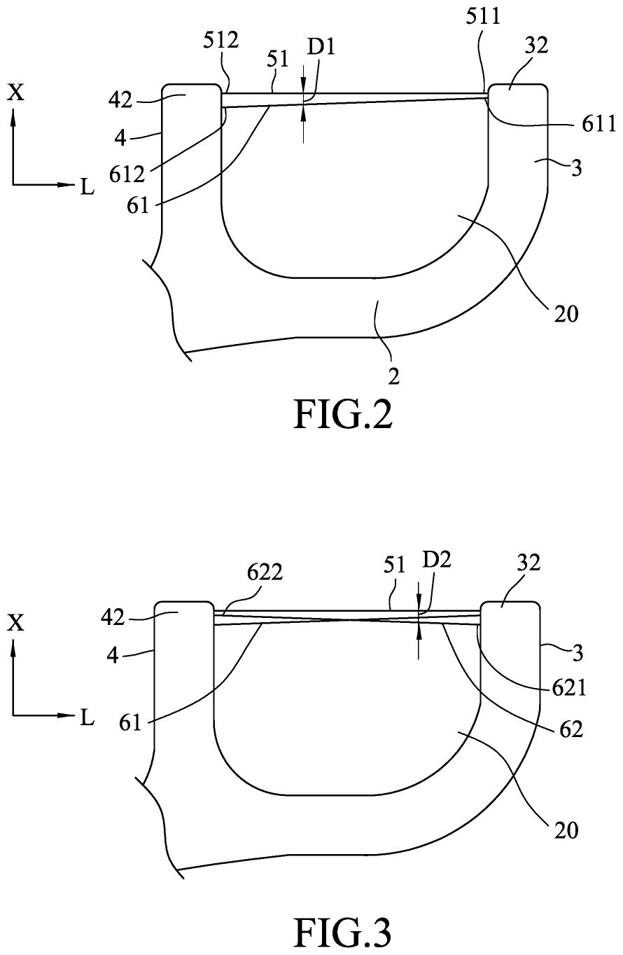

Referring to FIGS. 1 and 2, a floss stick according to a first embodiment of the present disclosure is shown. The floss stick includes a stick body 2, a first extension arm 3, a second extension arm 4, a first floss unit 5, and a second floss unit 6. The stick body 2 extends generally in a horizontal direction (L) and has a first end 21 and a second end 22 opposite to each other in the horizontal direction (L). The first extension arm 3 extends from the first end 21 of the stick body 2 in an extension direction (X) transverse to the horizontal direction (L), and includes a connecting end 31 and a mounting end 32. The connecting end 31 is connected to the stick body 2. The mounting end 32 is mounted with the first and second floss units 5, 6.

The second extension arm 4 extends from a portion of the stick body 2 disposed between the first end 21 and the second end 22, and includes a connecting end 41 and a mounting end 42. The connecting end 41 is connected to the stick body 2. The mounting end 42 is mounted with the first and second floss units 5, 6. The first and second extension arms 3, 4 cooperate with each other to define a cleaning area 20 therebetween. In this embodiment, the first and second extension arms 3, 4 and the stick body 2 are formed integrally.

The first and second floss units 5, 6 are mounted in the cleaning area 20 and are adapted for removing dental plaque from teeth. The first floss unit 5 includes a first horizontal floss 51 connected between the first and second extension arms 3, 4 and extending in a direction generally parallel to the horizontal direction (L). The first horizontal floss 51 has first and second ends 511, 512 connected respectively to the mounting ends 32, 42 of the first and second extension arms 3, 4. The second floss unit 6 includes a first inclined floss 61 connected between the first and second extension arms 3, 4, inclined relative to the first horizontal floss 51, and cooperating with the first horizontal floss 51 to define a first gap (D1) therebetween, in which the dental plaque removed by the first and second floss units 5, 6 is confined by capillary action. The first inclined floss 61 has first and second ends 611, 612 connected respectively to the mounting ends 32, 42 of the first and second extension arms 3, 4, and is disposed closer to the stick body 2 than the first horizontal floss 51.

As shown in FIG. 2, the first gap (D1) has a dimension in the extension direction (X) increasing gradually from the first extension arm 3 to the second extension arm 4.

Referring to FIG. 3, the floss stick according to a second embodiment of the present disclosure is shown. The second embodiment is similar to the first embodiment and the differences therebetween reside in the following. In the second embodiment, the second floss unit 6 further includes a second inclined floss 62 connected between the first and second extension arms 3, 4, disposed closer to the stick body 2 than the first horizontal floss 51, intersecting with the first inclined floss 61, and cooperating with the first horizontal floss 51 to define a second gap (D2) therebetween. The second inclined floss 62 has first and second ends 621, 622 connected respectively to the mounting ends 32, 42 of the first and second extension arms 3, 4. The second gap (D2) has a dimension in the extension direction (X) decreasing gradually from the first extension arm 3 to the second extension arm 4. The first and second floss units 5, 6 are adapted for confining the dental plaque removed in the first and second gaps (D1, D2) by capillary action.

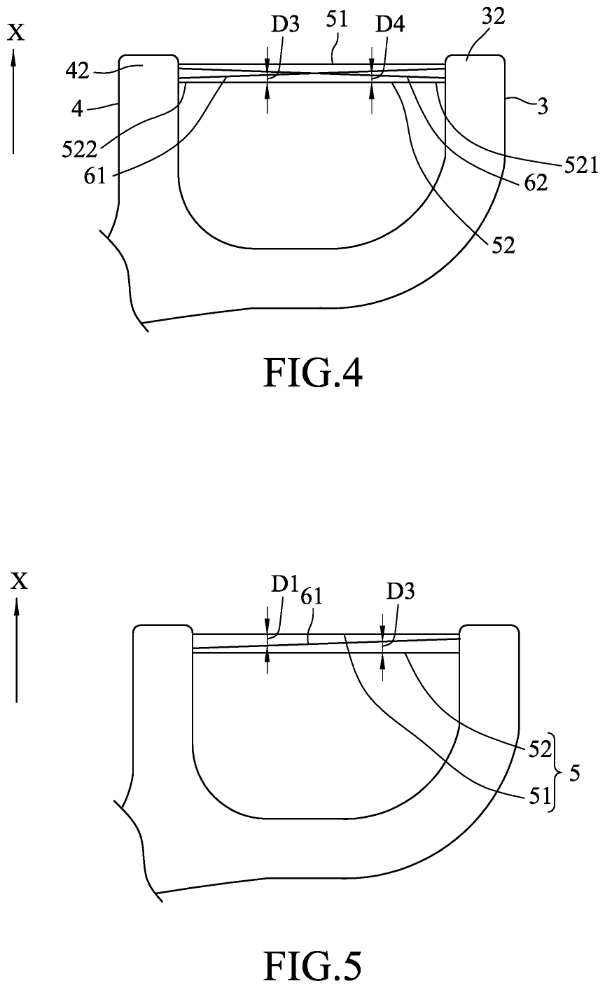

Referring to FIG. 4, the floss stick according to a third embodiment of the present disclosure is shown. The third embodiment is similar to the second embodiment and the differences therebetween reside in the following. In the third embodiment, the first floss unit 5 further includes a second horizontal floss 52 connected between the first and second extension arms 3, 4, disposed closer to the stick body 2 than the first horizontal floss 51, and parallel to and spaced apart from the first horizontal floss 51 in the extension direction (X). The second floss unit 6 is disposed between the first and second horizontal flosses 51, 52. The second horizontal floss 52 has first and second ends 521, 522 connected respectively to the mounting ends 32, 42 of the first and second extension arms 3, 4. The first inclined floss 61 cooperates with the second horizontal floss 52 to define a third gap (D3) therebetween. The third gap (D3) has a dimension in the extension direction (X) decreasing gradually from the first extension arm 3 to the second extension arm 4. The second inclined floss 62 cooperates with the second horizontal floss 52 to define a fourth gap (D4) therebetween. The fourth gap (D4) has a dimension in the extension direction (X) increasing gradually from the first extension arm 3 to the second extension arm 4. The first and second floss units 5, 6 are adapted for confining the dental plaque removed in the first, second, third, and fourth gaps (D1, D2, D3, D4) by capillary action.

Referring to FIG. 5, the floss stick according to a fourth embodiment of the present disclosure is shown. The fourth embodiment is similar to the third embodiment and the differences therebetween reside in that in the fourth embodiment, the second inclined floss 62 of the second floss unit 6 shown in FIG. 4 is omitted. The first and second floss units 5, 6 are adapted for confining the dental plaque removed in the first and third gaps (D1, D3) by capillary action.

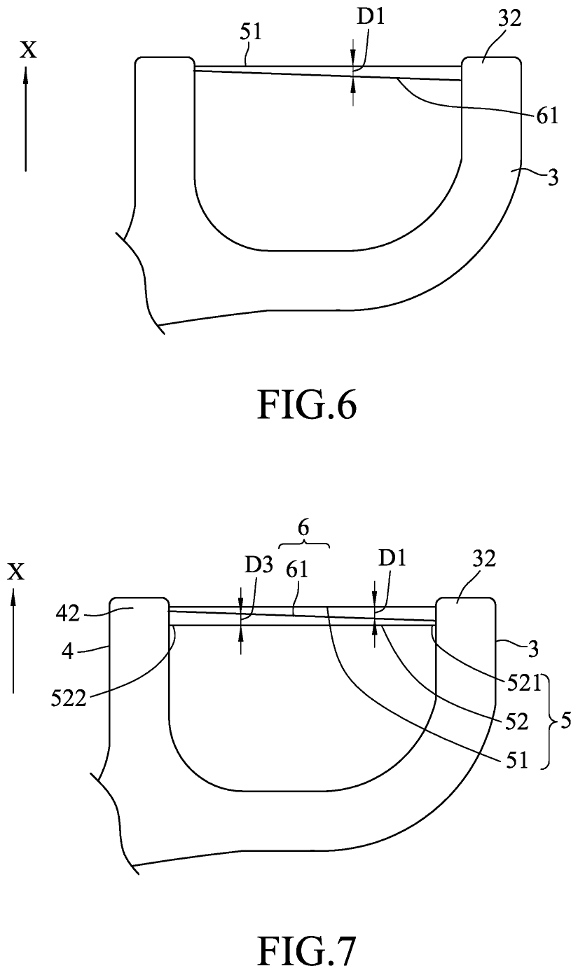

Referring to FIG. 6, the floss stick according to a fifth embodiment of the present disclosure is shown. The fifth embodiment is similar to the first embodiment and the differences therebetween reside in that the first gap (D1) defined between the first horizontal floss 51 and the first inclined floss 61 has a dimension in the extension direction (X) decreasing gradually from the first extension arm 3 to the second extension arm 4.

Referring to FIG. 7, the floss stick according to a sixth embodiment of the present disclosure is shown. The sixth embodiment is similar to the fifth embodiment and the differences therebetween reside in the following. In the sixth embodiment, the first floss unit 5 further includes a second horizontal floss 52 connected between the first and second extension arms 3, 4, disposed closer to the stick body 2 than the first horizontal floss 51, and parallel to and spaced apart from the first horizontal floss 51 in the extension direction (X). The second horizontal floss 52 has first and second ends 521, 522 connected respectively to the mounting ends 32, 42 of the first and second extension arms 3, 4. The first inclined floss 61 is disposed between the first and second horizontal flosses 51, 52 and cooperates with the second horizontal floss 52 to define a second gap (D3) therebetween. The second gap (D3) has a dimension in the extension direction (X) increasing gradually from the first extension arm 3 to the second extension arm 4. The first and second floss units 5, 6 are adapted for confining the dental plaque removed in the first and second gaps (D1, D3) by capillary action.

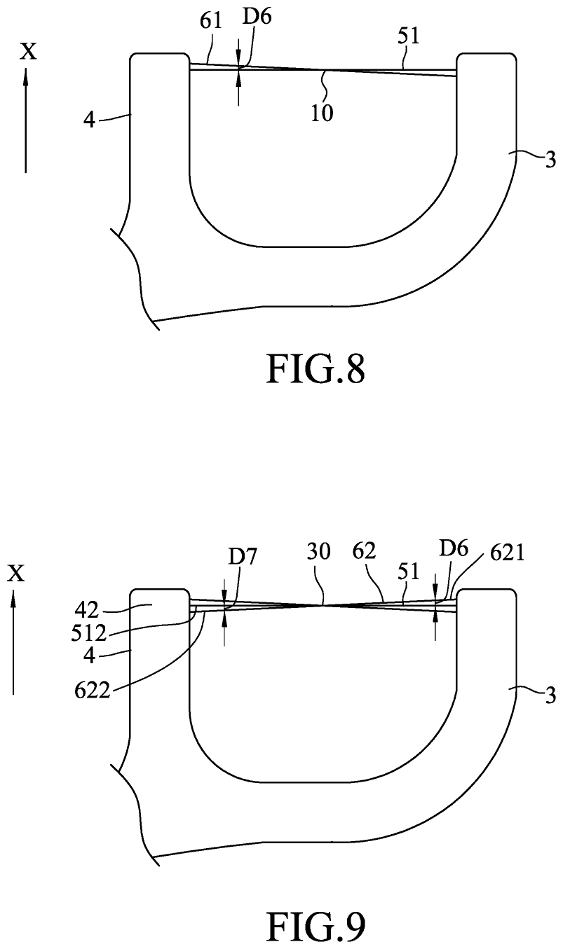

Referring to FIG. 8, the floss stick according to a seventh embodiment of the present disclosure is shown. The seventh embodiment is similar to the first embodiment and the differences therebetween reside in the following. In the seventh embodiment, the first horizontal floss 51 of the first floss unit 5 intersects with the first inclined floss 61 of the second floss unit 6 at an intersection point 10 to define the first gap (D6). The first gap (D6) has a dimension in the extension direction (X) decreasing gradually from the first extension arm 3 to the intersection point 10 and increasing gradually from the intersection point 10 to the second extension arm 4.

Referring to FIG. 9, the floss stick according to an eighth embodiment of the present disclosure is shown. The eighth embodiment is similar to the seventh embodiment and the differences therebetween reside in the following. In the eighth embodiment, the second floss unit 6 further includes a second inclined floss 62 connected between the first and second extension arms 3, 4, intersecting with the first inclined floss 61 and the first horizontal floss 51 at an intersection point 30. The second inclined floss 62 cooperates with the first horizontal floss 51 to define a second gap (D7) therebetween. The second gap (D7) has a dimension in the extension direction (X) decreasing gradually from the first extension arm 3 to the intersection point 30 and increasing gradually from the intersection point 30 to the second extension arm 4. The first and second floss units 5, 6 are adapted for confining the dental plaque removed in the first gap (D6) and the second gap (D7) by capillary action.

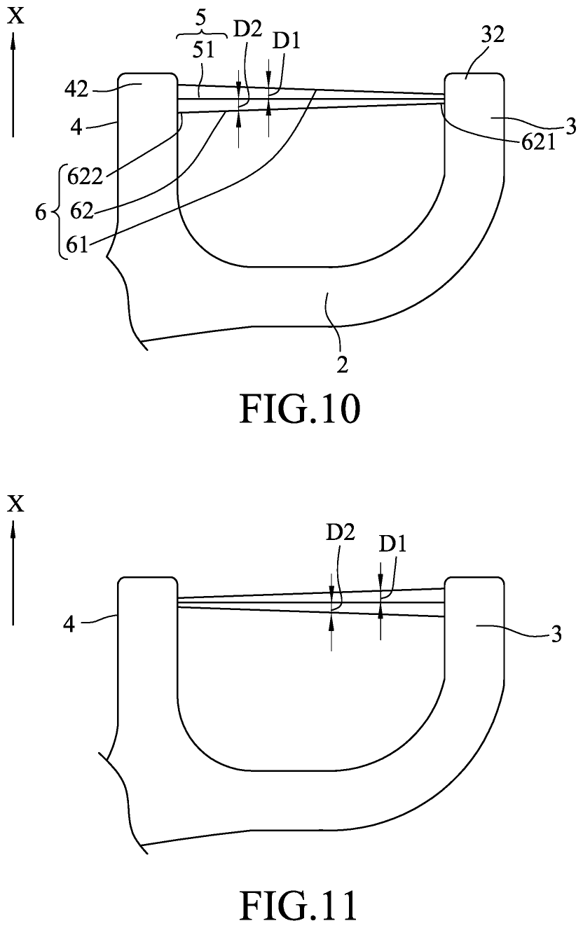

Referring to FIG. 10, the floss stick according to a ninth embodiment of the present disclosure is shown. The ninth embodiment is similar to the first embodiment and the differences therebetween reside in the following. In the ninth embodiment, the first inclined floss 61 is disposed farther from the stick body 2 than the first horizontal floss 51 in the extension direction (X). The second floss unit 6 further includes a second inclined floss 62 connected between the first and second extension arms 3, 4, disposed closer to the stick body 2 than the first horizontal floss 51 in the extension direction (X), and cooperating with the first horizontal floss 51 to define a second gap (D2) therebetween. The second inclined floss 62 has first and second ends 621, 622 connected respectively to the mounting ends 32, 42 of the first and second extension arms 3, 4. The second gap (D2) has a dimension in the extension direction (X) increasing gradually from the first extension arm 3 to the second extension arm 4. The first and second floss units 5, 6 are adapted for confining the dental plaque removed in the first gap (D1) and the second gap (D2) by capillary action.

Referring to FIG. 11, the floss stick according to a tenth embodiment of the present disclosure is shown. The tenth embodiment is similar to the ninth embodiment and the differences therebetween reside in the following. In the tenth embodiment, each of the first and second gaps (D1, D2) has a dimension in the extension direction (X) decreasing gradually from the first extension arm 3 to the second extension arm 4.

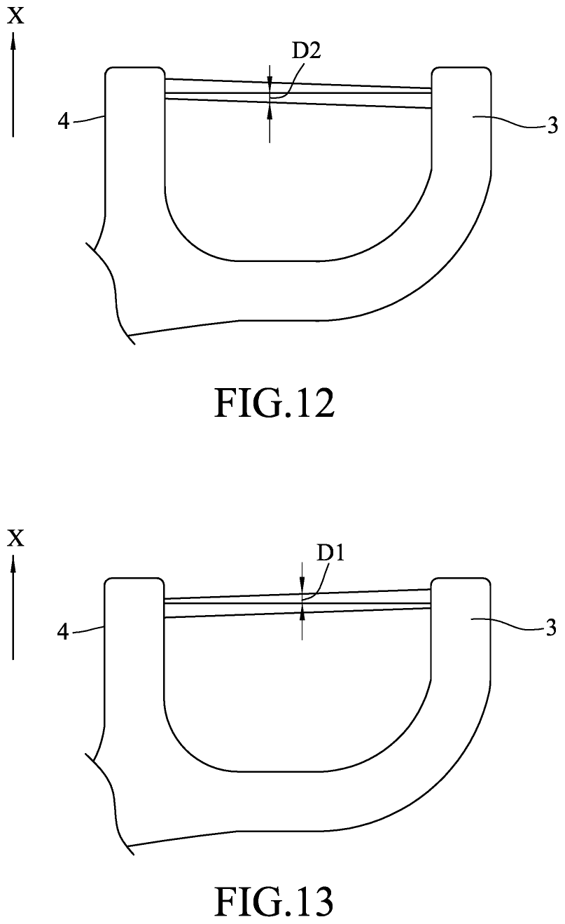

Referring to FIG. 12, the floss stick according to an eleventh embodiment of the present disclosure is shown. The eleventh embodiment is similar to the ninth embodiment and the differences therebetween reside in that the second gap (D2) has a dimension in the extension direction (X) decreasing gradually from the first extension arm 3 to the second extension arm 4.

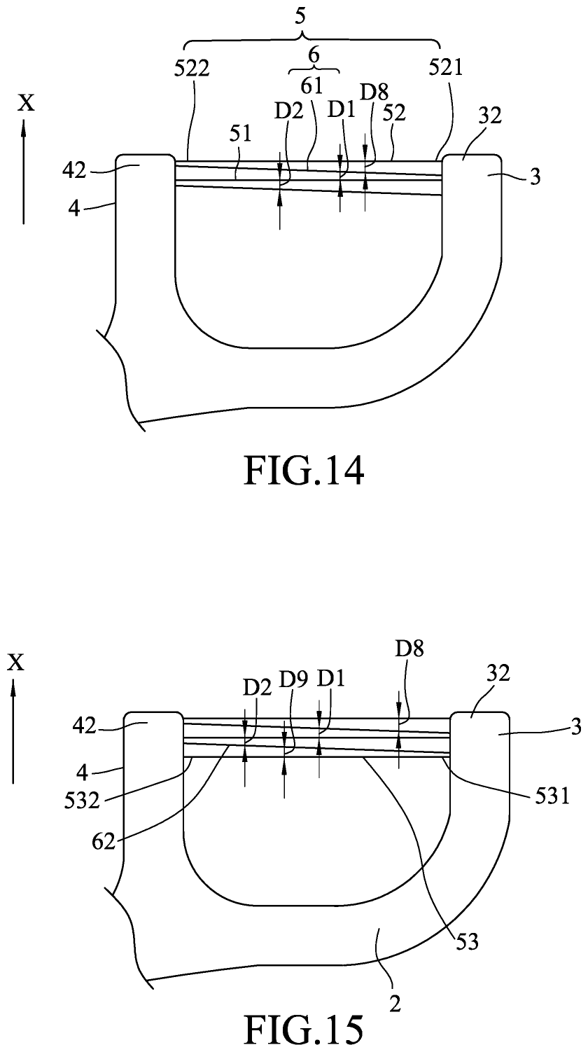

Referring to FIG. 13, the floss stick according to a twelfth embodiment of the present disclosure is shown. The twelfth embodiment is similar to the ninth embodiment and the differences therebetween reside in that the first gap (D1) has a dimension in the extension direction (X) decreasing gradually from the first extension arm 3 to the second extension arm 4.

Referring to FIG. 14, the floss stick according to a thirteenth embodiment of the present disclosure is shown. The thirteenth embodiment is similar to the eleventh embodiment and the differences therebetween reside in the following. In the thirteenth embodiment, the first floss unit 5 further includes a second horizontal floss 52 connected between the first and second extension arms 3, 4, parallel to and spaced apart from the first horizontal floss 51 in the extension direction (X), and disposed farther from the stick body 2 than the first inclined floss 61 in the extension direction (X). The second horizontal floss 52 has first and second ends 521, 522 connected respectively to the mounting ends 32, 42 of the first and second extension arms 3, 4. The second horizontal floss 52 cooperates with the first inclined floss 61 to define a third gap (D8) that has a dimension in the extension direction (X) decreasing gradually from the first extension arm 3 to the second extension arm 4. The first and second floss units 5, 6 are adapted for confining the dental plaque removed in the first, second, and third gaps (D1, D2, D8) by capillary action.

Referring to FIG. 15, the floss stick according to a fourteenth embodiment of the present disclosure is shown. The fourteenth embodiment is similar to the thirteenth embodiment and the differences therebetween reside in the following. In the fourteenth embodiment, the first floss unit 5 further includes a third horizontal floss 53 connected between the first and second extension arms 3, 4, and disposed closer to the stick body 2 than the second inclined floss 62 in the extension direction (X). The third horizontal floss 53 has first and second ends 531, 532 connected respectively to the mounting ends 32, 42 of the first and second extension arms 3, 4. The third horizontal floss 53 cooperates with the second inclined floss 62 to define a fourth gap (D9) therebetween. The fourth gap (D9) has a dimension in the extension direction (X) increasing gradually from the first extension arm 3 to the second extension arm 4. The first and second floss units 5, 6 are adapted for confining the dental plaque removed in the first, second, third and fourth gaps (D1, D2, D8, D9) by capillary action.

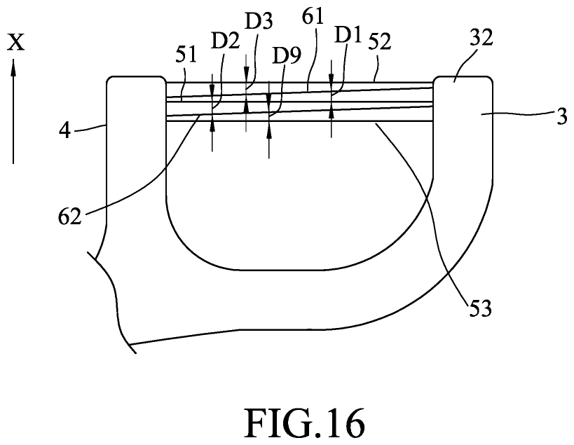

Referring to FIG. 16, the floss stick according to a fifteenth embodiment of the present disclosure is shown. The fifteenth embodiment is similar to the fourteenth embodiment and the differences therebetween reside in the following. In the fifteenth embodiment, each of the first and fourth gaps (D1, D9) has a dimension in the extension direction (X) decreasing gradually from the first extension arm 3 to the second extension arm 4. Each of the second and third gaps (D2, D3) has a dimension in the extension direction (X) increasing gradually from the first extension arm 3 to the second extension arm 4.

It should be noted that the numbers of the horizontal and inclined flosses of the first and second floss units 5, 6 are not limited to the embodiments described herein as long as at least one gap in which the dental plaque removed by the first and second floss units 5, 6 is confined by capillary action can be defined between the first and second floss units 5, 6.

In the following description, some experimental results of dental plaque removal rate using the floss stick of the present disclosure are illustrated. A high-resolution camera (e.g., a camera with 20.2 megapixels resolution, model No. G7X manufactured by Canon incorporated) is employed to take pictures of the surfaces of a pair of adjacent teeth facing each other, but the present disclosure is not limited to the camera model used herein. The pictures are analyzed using analysis software such as Adobe Photoshop® to perform optical analysis so as to calculate a plaque distribution rate (T0) which is equal to an area of the dental plaque divided by an area of the tooth surfaces multiplied by 100%. Subsequently, the floss stick of the present disclosure is moved into and out of a space between the pair of teeth to remove the dental plaque, and the action of moving the floss stick back and forth represents one reciprocal action. The camera sequentially captures a plurality of pictures of the surfaces of the pair of teeth respectively after the first reciprocal action, the second reciprocal action, the third reciprocal action and the fourth reciprocal action to obtain first, second, third and fourth plaque distribution rates (T1, T2, T3, T4) respectively corresponding to the first to the fourth reciprocal actions. Finally, a dental plaque removal rate after each of the first to the fourth moves is calculated. For example, the dental plaque removal rate after the first reciprocal action of the floss stick is (T0−T1)/T0, wherein T0 is the original plaque distribution rate, and T1 is the plaque distribution rate after the first reciprocal action. In the first, the second, and the fifth to the twelfth embodiments of the present disclosure, the dental plaque removal rates after the first reciprocal action are 80%, the dental plaque removal rates after the second reciprocal action are 89%, the dental plaque removal rates after the third reciprocal action are 94%, and the dental plaque removal rates after the fourth reciprocal action are 98%. In the third, fourth, thirteenth embodiments, the dental plaque removal rates after the first reciprocal action are 83%, the dental plaque removal rates after the second reciprocal action are 92%, the dental plaque removal rates after the third reciprocal action are 96%, and the dental plaque removal rates after the fourth reciprocal action are 99%. In the fourteenth and the fifteenth embodiments, the dental plaque removal rates after the first reciprocal action are 93%, the dental plaque removal rates after the second reciprocal action are 95%, the dental plaque removal rates after the third reciprocal action are 97%, and the dental plaque removal rates after the fourth reciprocal action are 99.5%.

To sum up, by virtue of the structures of the floss stick of the present disclosure, the dental plaque removed by the first and second floss units 5, 6 is confined in the gaps defined between the first and second floss units 5, 6 by capillary action in a relatively efficient manner.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A floss stick comprising:
a stick body extending generally in a horizontal direction;
a first extension arm extending from said stick body in an extension direction transverse to the horizontal direction;
a second extension arm extending from said stick body in the extension direction, spaced apart from said first extension arm in the horizontal direction, and cooperating with said first extension arm to define a cleaning area therebetween;
a first floss unit mounted in said cleaning area, adapted for removing dental plaque from teeth, and including
a first horizontal floss connected between said first extension arm and said second extension arm and extending in a direction generally parallel to the horizontal direction; and
a second floss unit mounted in said cleaning area and adapted for removing dental plaque from teeth, and including
a first inclined floss connected between said first extension arm and said second extension arm, inclined relative to said first horizontal floss, and cooperating with said first horizontal floss to define a first gap therebetween, in which the dental plaque removed is confined by capillary action.

2. The floss stick as claimed in claim 1, wherein said first gap has a dimension in the extension direction increasing gradually from said first extension arm to said second extension arm.

3. The floss stick as claimed in claim 2, wherein said second floss unit further includes a second inclined floss connected between said first extension arm and said second extension arm, intersecting with said first inclined floss, and cooperating with said first horizontal floss to define a second gap therebetween, said second gap having a dimension in the extension direction decreasing gradually from said first extension arm to said second extension arm, said first floss unit and said second floss unit being adapted for confining the dental plaque removed in said first gap and said second gap by capillary action.

4. The floss stick as claimed in claim 3, wherein said first floss unit further includes a second horizontal floss connected between said first extension arm and said second extension arm and parallel to and spaced apart from said first horizontal floss in the extension direction, said second floss unit being disposed between said first horizontal floss and said second horizontal floss, said first inclined floss cooperating with said second horizontal floss to define a third gap therebetween, said third gap having a dimension in the extension direction decreasing gradually from said first extension arm to said second extension arm, said second inclined floss cooperating with said second horizontal floss to define a fourth gap therebetween, said fourth gap having a dimension in the extension direction increasing gradually from said first extension arm to said second extension arm, said first floss unit and said second floss unit being adapted for confining the dental plaque removed in said first gap, said second gap, said third gap and said fourth gap by capillary action.

5. The floss stick as claimed in claim 2, wherein said first inclined floss is disposed farther from said stick body than said first horizontal floss in the extension direction, said second floss unit further including a second inclined floss connected between said first extension arm and said second extension arm, disposed closer to said stick body than said first horizontal floss in the extension direction, and cooperating with said first horizontal floss to define a second gap therebetween, said second gap having a dimension in the extension direction increasing gradually from said first extension arm to said second extension arm, said first floss unit and said second floss unit being adapted for confining the dental plaque removed in said first gap and said second gap by capillary action.

6. The floss stick as claimed in claim 2, wherein said first floss unit further includes a second horizontal floss connected between said first extension arm and said second extension arm and parallel to and spaced apart from said first horizontal floss in the extension direction, said first inclined floss of said second floss unit being disposed between said first horizontal floss and said second horizontal floss, said second horizontal floss cooperating with said first inclined floss to define a second gap therebetween, said second gap having a dimension in the extension direction decreasing gradually from said first extension arm to said second extension arm, said first floss unit and said second floss unit being adapted for confining the dental plaque removed in said first gap and said third gap by capillary action.

7. The floss stick as claimed in claim 1, wherein said first gap has a dimension in the extension direction decreasing gradually from said first extension arm to said second extension arm.

8. The floss stick as claimed in claim 7, wherein said first floss unit further includes a second horizontal floss connected between said first extension arm and said second extension arm and parallel to and spaced apart from said first horizontal floss in the extension direction, said first inclined floss being disposed between said first horizontal floss and said second horizontal floss and cooperating with said second horizontal floss to define a second gap therebetween, said second gap having a dimension in the extension direction increasing gradually from said first extension arm to said second extension arm, said first floss unit and said second floss unit being adapted for confining the dental plaque removed in said first gap and said second gap by capillary action.

9. The floss stick as claimed in claim 7, wherein said first inclined floss is disposed farther from said stick body than said first horizontal floss in the extension direction, said second floss unit further including a second inclined floss connected between said first extension arm and said second extension arm, disposed closer to said stick body than said first horizontal floss in the extension direction, and cooperating with said first horizontal floss to define a second gap therebetween, said second gap having a dimension in the extension direction decreasing gradually from said first extension arm to said second extension arm, said first floss unit and said second floss unit being adapted for confining the dental plaque removed in said first gap and said second gap by capillary action.

10. The floss stick as claimed in claim 1, wherein said first horizontal floss of said first floss unit intersects with said first inclined floss of said second floss unit at an intersection point to define the first gap that has a dimension in the extension direction decreasing gradually from said first extension arm to the intersection point and increasing gradually from the intersection point to said second extension arm.

11. The floss stick as claimed in claim 10, wherein said second floss unit further includes a second inclined floss connected between said first extension arm and said second extension arm, intersecting with said first inclined floss and said first horizontal floss at the intersection point, and cooperating with said first horizontal floss to define a second gap therebetween, said second gap having a dimension in the extension direction decreasing gradually from said first extension arm to the intersection point and increasing gradually from said intersection point to said second extension arm, said first floss unit and said second floss unit being adapted for confining the dental plaque removed in said first gap and said second gap by capillary action.

12. The floss stick as claimed in claim 1, wherein said first inclined floss is disposed farther from said stick body than said first horizontal floss in the extension direction, said second floss unit further including a second inclined floss connected between said first extension arm and said second extension arm, disposed closer to said stick body than said first horizontal floss in the extension direction, and cooperating with said first horizontal floss to define a second gap therebetween, said second gap having a dimension in the extension direction, said first floss unit and said second floss unit being adapted for confining the dental plaque removed in said first gap and said second gap by capillary action,
one of said first gap and said second gap has a dimension in the extension direction decreasing gradually from said first extension arm to said second extension arm, and the other one of said first gap and said second gap has a dimension in the extension direction increasing gradually from said first extension arm to said second extension arm.

13. The floss stick as claimed in claim 12, wherein said first floss unit further includes a second horizontal floss connected between said first extension arm and said second extension arm, parallel to and spaced apart from said first horizontal floss in the extension direction, and disposed farther from said stick body than said first inclined floss in the extension direction, said second horizontal floss cooperating with said first inclined floss to define a third gap that has a dimension in the extension direction decreasing gradually from said first extension arm to said second extension arm, said first floss unit and said second floss unit being adapted for confining the dental plaque removed in said first gap, said second gap and said third gap by capillary action.

14. The floss stick as claimed in claim 13, wherein said first floss unit further includes a third horizontal floss connected between said first extension arm and said second extension arm, and disposed closer to said stick body than said second inclined floss in the extension direction, said third horizontal floss cooperating with said second inclined floss to define a fourth gap therebetween, said fourth gap having a dimension in the extension direction increasing gradually from said first extension arm to said second extension arm, said first floss unit and said second floss unit being adapted for confining the dental plaque removed in said first, second, third and fourth gaps by capillary action.

15. The floss stick as claimed in claim 12, wherein said first floss unit further includes a second horizontal floss connected between said first extension arm and said second extension arm, parallel to and spaced apart from said first horizontal floss in the extension direction, and disposed farther from said stick body than said first inclined floss in the extension direction, said second horizontal floss cooperating with said first inclined floss to define a third gap therebetween, said third gap having a dimension in the extension direction increasing gradually from said first extension arm to said second extension arm, said first floss unit further including a third horizontal floss connected between said first extension arm and said second extension arm, and disposed closer to said stick body than said second inclined floss in the extension direction, said third horizontal floss cooperating with said second inclined floss to define a fourth gap therebetween, said fourth gap having a dimension in the extension direction decreasing gradually from said first extension arm to said second extension arm, said first floss unit and said second floss unit being adapted for confining the dental plaque removed in said first, second, third and fourth gaps by capillary action.

16. The floss stick as claimed in claim 1, wherein said stick body has a first end and a second end opposite to each other in the horizontal direction, said first extension arm extending from said first end of said stick body in the extension direction, said second extension arm extending from a portion of said stick body disposed between said first end and said second end.
